(19) United States
(12) Patent Application Publication
(10) Pub. No.: US 2026/0175875 A1
(43) Pub. Date: Jun. 25, 2026

(54) TRAFFIC SIGNAL BEHAVIOR PARAMETER CONFIGURATION FOR AUTONOMOUS VEHICLES

(71) Applicant: Zoox, Inc., Foster City, CA (US)

(72) Inventors: Giorgos Mamakoukas, Cambridge, MA (US); Akash Arora, Redwood City, CA (US); Davide Callegaro, Oakland, CA (US); Joseph Funke, Redwood City, CA (US); Scott Bowes Hamill, San Mateo, CA (US); Yunpeng Pan, Newark, CA (US); Logan Yliniemi, Medford, MA (US)

(21) Appl. No.: 18/990,194

(22) Filed: Dec. 20, 2024

(51) Int. Cl. B60W 60/00; B60W 30/18

(52) U.S. Cl. CPC B60W 60/0015; B60W 30/18159; B60W 2555/60

(57) ABSTRACT

Techniques are described herein for evaluating and tuning parameters for controlling the behavior of an autonomous vehicle in or near intersections controlled by traffic signals. A planning component of an autonomous vehicle may use a set of traffic signal parameters to compute trajectory costs for the vehicle associated with traversing an intersection controlled by a traffic signal in a non-permissible state (e.g., a red light). A parameter tuning system may execute driving simulations using the planning component and a candidate set of parameters to control the behavior of a simulation vehicle within a training data set of traffic signal intersections. The parameter tuning system may determine performance metrics based on the behaviors of the simulated vehicle and may execute a search algorithm to determine modified (e.g., optimal) parameter sets for controlling vehicles during real-world driving scenarios having intersections controlled by traffic signals.

### BACKGROUND

Autonomous driving may benefit from computing systems capable of determining driving paths and navigating along routes from an initial location toward a destination. For example, autonomous and semi-autonomous vehicles may utilize systems and components to traverse through driving environments including other objects, such as moving or stationary vehicles (autonomous or otherwise), pedestrians, buildings, etc. When traversing through such an environment, the vehicle may determine a trajectory based on sensor data from the perception systems of the vehicle, as well as map data of the environment. A planning system within an autonomous or semi-autonomous vehicle may determine a trajectory and a corresponding set of actions for the vehicle to take to navigate in an operating environment. Trajectory selection techniques may take into account considerations such as kinematic and/or dynamic (kino-dynamic) feasibility of the vehicle, passenger safety and comfort, driving efficiency, route continuity, and the like. Additionally, the trajectory and actions determined by a vehicle may be determined based in part on avoiding other objects present in the environment. For example, an action may be generated by a planning system to yield to a pedestrian, to change a lane to avoid another vehicle on the road, etc. The perception systems of the vehicle utilize sensor data to perceive the environment, which also enables the planning system to determine the effect of a detected object on the potential actions for the vehicle. However, the complexity of such environments may preclude the efficient determination of optimized trajectories for the vehicle, especially as applied in ever more complicated scenarios.

### BRIEF DESCRIPTION OF THE DRAWINGS

The detailed description is described with reference to the accompanying figures. In the figures, the leftmost digit(s) of a reference number identifies the figure in which the reference number first appears. The use of the same reference numbers in different figures indicates similar or identical components or features.

FIG. 1 illustrates an example diagram depicting a vehicle operating in a driving environment, in accordance with one or more examples of the disclosure.

FIG. 2 is a block diagram illustrating an example system for tuning and validating a parameter set for controlling vehicles in traffic signal driving scenarios, demonstrating the process flow for optimizing autonomous vehicle behavior, in accordance with one or more examples of the disclosure.

FIG. 3A and FIG. 3B illustrate graphs representing example traffic signal cost functions, in accordance with one or more examples of the disclosure.

FIG. 4 illustrates a first example system diagram for a parameter tuning component, including a first example set of components and data flow for optimizing a traffic signal parameter set, in accordance with one or more examples of the disclosure.

FIG. 5 is an example diagram depicting a planning component evaluating costs associated with potential trajectories in a traffic signal driving scenario, in accordance with one or more examples of the disclosure.

FIG. 6 depicts a block diagram of an example system for implementing various techniques described herein.

### DETAILED DESCRIPTION

This application describes techniques for evaluating and tuning parameter sets used to control autonomous vehicles in or near intersections controlled by traffic signals. As described herein, traffic signal parameters may include a set of parameters used by a driving algorithm (e.g., a planning component) of an autonomous vehicle to control the behavior of the autonomous vehicle while approaching and traversing through an intersection controlled by a traffic signal in a non-permissible state (e.g., a red light or stop state). In various examples, a parameter tuning system may execute driving simulations based on a training set of driving scenarios including intersections controlled by traffic signals. Within the simulations, a planning component may use a candidate set of traffic signal parameters to control the behavior of a simulation vehicle based on the permissibility state of the traffic signal. The parameter tuning system may determine one or more performance metrics associated with the parameter set based on the behaviors of the simulated vehicle during the simulated scenarios and may execute a search algorithm to determine modified parameter sets for improving the performance metrics. After determining an improved (e.g., optimized) set of traffic signal parameters, the improved parameter set may be provided to vehicles configured to use the traffic signal parameters to compute costs associated with approaching and traversing real-world driving scenarios with intersections controlled by traffic signals. The traffic signal costs may be evaluated in combination with additional costs relating to vehicle safety, passenger experience, route efficiency, and the like, and used to determine an optimal trajectory for the vehicle through real-world driving scenarios when changing and/or non-permissible traffic signals are encountered.

As used herein, a traffic signal driving scenario may refer to a driving scenario in which a vehicle passes through an intersection at least partially controlled by a traffic signal, during which the traffic signal may be in a non-permissible state (e.g., displaying a red light) for at least a portion of the time when the vehicle is occupying the intersection. Within such scenarios, certain existing driving algorithms for controlling autonomous vehicles may exhibit inconsistent or lower-quality driving behaviors in and around intersections controlled with traffic signals in non-permissible states. For example, it is generally preferable for a vehicle to pass through an intersection controlled by traffic signals when the signals are entirely in a permissible (or protected) state (e.g., displaying a green or yellow light). Accordingly, certain existing autonomous driving systems may use algorithms, optimization models, and other techniques that disincentivize the vehicle from driving through an intersection when the traffic signal is in a non-permissible state, such as when displaying a red light to the vehicle's lane of traffic.

However, it is not always desirable for a vehicle to pass through an intersection only when the traffic signal is displaying a green light. For example, when a traffic signal turns from green to yellow, it may be generally desirable behavior for an autonomous vehicle to proceed through the intersection under the yellow light when there is sufficient time to safely clear the intersection before the light changes to red. Similarly, it may be generally desirable for an autonomous vehicle to stop before the intersection when there is insufficient time to clear the intersection before the light changes to red. However, there may be various exceptions to these general rules. In some driving scenarios, it may be safer and better driving behavior for the vehicle to proceed through an intersection showing a yellow and/or red traffic signal, rather than stopping in a crosswalk or stopping too quickly and risking a rear-impact collision from a following vehicle, etc. Additionally, in driving scenarios that include slow-moving traffic, low visibility, and/or other complicating factors, it may be more different or impossible for the vehicle to entirely clear the intersection until after the light has changed to red.

Determining improved driving behaviors for autonomous vehicles in traffic signal scenarios may be a complex problem that is not suitable for optimizing using simple heuristics and cannot be performed by traditional techniques or by the human mind. For example, in autonomous vehicle systems, driving behaviors in and around intersections having traffic signals may be controlled by a combination of parameters that the vehicle may use to compute costs associated with a potential driving path or trajectory. Such costs may be weighed against other costs and considerations, including vehicle safety costs, passenger experience costs, driving efficiency costs, etc., to determine an overall optimal driving trajectory for the vehicle. The complexity of determining optimal driving behaviors in traffic signal intersections (e.g., intersections controlled by traffic signals in non-permissible states), as well as balancing these driving behaviors with the other relevant considerations necessitates more sophisticated approaches, including parameter optimization and behavior tuning for autonomous vehicles operating in environments with traffic signal intersections.

Accordingly, various techniques are described herein for evaluating and tuning sets of parameters (which may be referred to as “traffic signal parameters”) used by a traffic signal subcomponent of an autonomous vehicle to compute traffic signal costs, which may be used to control the behavior of the vehicle in and near intersections controlled by traffic signals. In some examples, an autonomous vehicle may include a planning component configured to execute one or more driving algorithms (e.g., heuristic-based algorithms, tree-search algorithms, and/or machine-learned models) that evaluate various possible trajectories and select an optimal (e.g., lowest-cost) trajectory for the vehicle to follow. For instance, a planning component may compute various types of positive and/or negative costs associated with the different driving behaviors and/or vehicle states within a potential trajectory. Such costs may include, for example, costs associated with the various vehicle speeds and/or accelerations in the potential trajectory (e.g., costs for excess speeds or accelerations, costs for driving too slowly or stopping on a roadway), costs associated with different lane positions and/or lane changes, costs associated with jittery or irregular driving behaviors, costs associated with high-risk driving maneuvers (e.g., costs for following too close, stopping in a crosswalk, etc.), and the like. To determine an optimal trajectory for the vehicle to follow, the planning component may aggregate the costs for any number of potential trajectories and may use the aggregated trajectory costs to select one or more of the trajectories as an optimal (e.g., lowest cost) trajectory.

As noted above, the planning component may compute and aggregate various types of costs for a potential trajectory, including vehicle and passenger safety costs, passenger experience costs, driving efficiency and route optimization costs, costs associated with conformance to traffic laws and other customary driving rules (e.g., proper yielding, passing, following distance, right-of-way abidance, etc.), and the like. Various techniques described herein may relate to a traffic signal subcomponent of the planning component that is configured to determine additional traffic signal costs, such as junction entry costs and junction blocking costs, that may be computed for a trajectory in which the vehicle passes through an intersection having a traffic signal in a non-permissible state (e.g., displaying a red light) for at least part of the time when the vehicle is in the intersection. These traffic signal costs may be computed based on a set of traffic signal parameters which may determine the magnitude of the costs based on the vehicle trajectory and the permissibility states of the traffic signal at various times during the trajectory. After computing the traffic signal costs for a trajectory, these costs may be aggregated with various other costs (e.g., safety costs, passenger experience costs, route efficiency costs, etc.) by the planning component and used to determine the optimal (e.g., lowest-cost) trajectory for the vehicle.

In various examples herein, a parameter tuning system may be configured to determine improved and/or optimal sets of traffic signal parameters for controlling autonomous vehicles in and around traffic signal intersections. Initially, the parameter tuning system may execute a set of driving simulations using a training set of traffic signal driving scenarios (e.g., scenarios including intersections with traffic signals changing to non-permissible states). When executing the driving simulations, a simulation system may use a planning component configured to compute traffic signal costs based on a candidate set of traffic signal parameters and/or set of traffic signal functions. The parameter tuning system may calculate various performance metric scores based on the results of the driving simulations, to evaluate and quantify the driving behaviors of the simulated vehicle during the traffic signal scenarios. For example, a first performance metric may indicate the amount of time between the time in the driving simulation when the simulated vehicle (e.g., controlled by the planning component using traffic signal parameters) enters the intersection and the time when the traffic signal changes to red. As another example, a second performance metric may indicate the duration of time during the driving simulation that the simulated vehicle is occupying a cross-traffic lane within the intersection while the traffic signal is red. In various examples, any number of performance metrics may be used to evaluate the behavior of the simulated vehicle relative to traffic signal intersections within the training set of traffic signal scenarios.

After executing a set of driving simulations based on the traffic signal training scenarios, the parameter tuning system may use the sets of traffic signal parameters and corresponding performance metric scores to modify (or tune) the traffic signal parameters in order to improve and/or optimize the performance of the autonomous vehicle during traffic signal driving scenarios. As described below in more detail, a set of traffic signal parameters may include any number of parameters, which may be constrained or unconstrained, resulting in a large multidimensional parameter search space. The traffic signal parameters may represent the parameters of various traffic signal cost functions executed by the planning component, including parameters representing cost delay times, maximum costs, cost rate slopes, coefficients defining quadratic cost curves, x- and y-intercept values, and the like. Due to the size of the parameter search space and the complex and obscure relationships between parameter sets and corresponding performance metric scores, optimization of the traffic signal parameters may be unsuitable for manual tuning.

Accordingly, in some examples, the parameter tuning system may include automated tuning components configured with various search algorithms to select and optimize candidate sets of traffic signal parameters for validation. For instance, a parameter tuning component may execute various types of search algorithms (e.g., random search, grid search, Bayesian optimization, gradient-free optimization, etc.) to identify improved and/or optimized candidate sets of parameters within the parameter search space. In some examples, the parameter tuning component may perform a multi-stage optimization process, including performing an initial grid search and a filtering/clustering based on a first set of performance metrics (e.g., safety metrics, traffic signal performance metrics, etc.), and then subsequently performing an optimization algorithm (e.g., Bayesian optimization) to further optimize the parameter set based on additional traffic signal performance metrics.

After determining and validating a modified (e.g., improved or optimized) set of traffic signal parameters, the parameter tuning system may provide the modified parameters to one or more vehicles operating in real-world driving environments. The vehicles may use the modified traffic signal parameters (e.g., via the planning components) to control the driving behavior of the vehicle when approaching and traversing intersections having traffic signals in non-permissible states. For example, as noted above, the vehicles may use the traffic signal parameters to parameterize the complex cost functions (e.g., junction entry and/or junction blocking cost functions) executed by the planning component during trajectory generation and optimization. Using these cost functions, the vehicle may select between alternative driving paths and trajectories when approaching and passing through traffic signal intersections. For instance, based on the traffic signal costs determined using the parameters, an autonomous vehicle may select between trajectories that stop before an intersection or proceed through the intersection in various ways under non-permissible stop states.

The techniques described herein for parameter evaluation and tuning for traffic signal parameters offer significant technical improvements in the operation and safety of autonomous vehicles when navigating through intersections controlled by traffic signals. By employing advanced parameter tuning and optimization algorithms, these techniques enable more sophisticated and dynamic behavior adjustments based on real-time changes in traffic conditions and signal permissibility. This leads to improved decision-making capabilities for autonomous vehicles, particularly in complex urban environments where traffic signals play a critical role in traffic management.

One of the primary technical benefits of the techniques described herein is improved accuracy and decision-making when performing trajectory planning for autonomous vehicles. By improving and/or optimizing traffic signal parameters, the planning component can use the optimized parameters to determine, for example, whether it is safer to stop at a yellow light or proceed through the intersection, based on the specific timing of the light change and conjunction with the various other aspects of driving environment. Thus, these techniques may not only enhance safety by reducing the likelihood of accidents but also may improve the flow of traffic by minimizing unnecessary stops and delays.

Further, these techniques provide additional support for using complex parameterized cost functions for evaluating vehicle behaviors in traffic signal driving scenarios. As discussed above, these cost functions have large parameter search spaces, and the relationships between the parameter sets and corresponding performance metric scores are complex and obscure, making the optimization of the traffic signal parameters unsuitable for manual tuning. Thus, by efficiently determining the optimal set of parameters through algorithms such as Bayesian optimization or gradient-free optimization, the use of filtering and clustering, etc., these techniques may enable more complex cost functions to support more robust and nuanced driving behaviors in traffic signal driving scenarios.

Although various examples herein relate to improving the traffic signal parameters used by a planning component to control the vehicle in traffic signal driving scenarios, the same concepts and/or techniques also may be applied to improving/optimizing additional parameter sets used by the planning component to control the vehicle in other types of discrete driving scenarios. In general, the techniques described herein may be used to tune any parameter set associated with a particular type of discrete driving maneuver or scenario, for which the performance of the vehicle is capable of being evaluated by metrics, and wherein the relationship between the parameters and the performance metrics is complex and/or obscure. For instance, similar or identical techniques to those described herein can be used to modify (or tune) a separate set of vehicle pullover parameters that the planning component may use to control the vehicle when performing pullover driving maneuvers (e.g., pick-ups or drop-offs) at curbsides, roadway shoulders, hotel or airport passenger drop-off areas, etc. As another example, similar or identical techniques can be used to modify/tune a set of parameters that the planning component may use to perform off-road to on-road driving maneuvers, or vice versa.

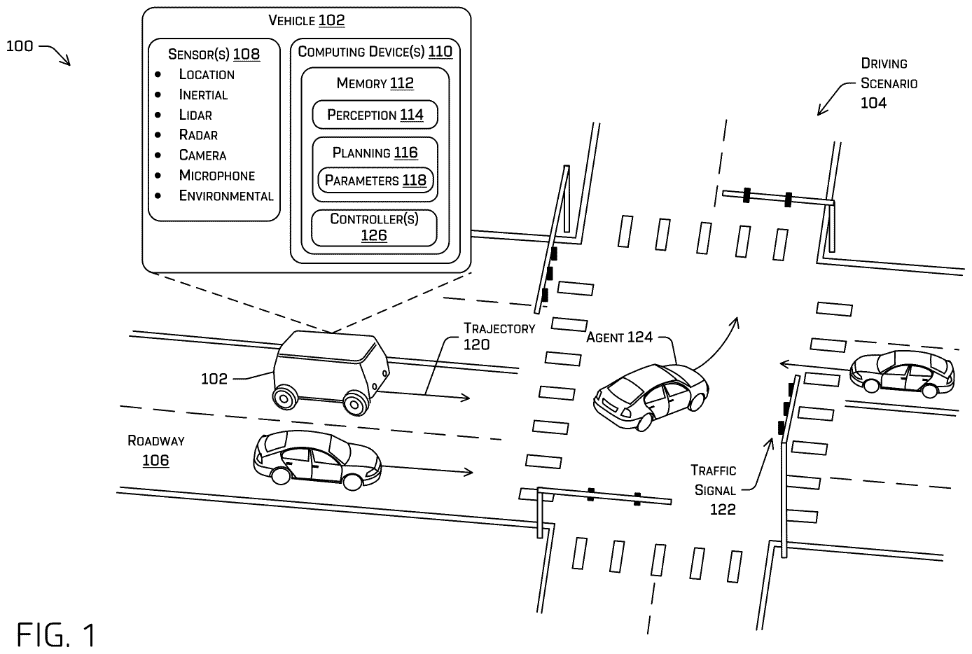

FIG. 1 shows an example diagram 100 in which a vehicle 102 (e.g., an autonomous vehicle) is operating in a driving scenario 104 on a roadway 106 in a real-world driving environment. Although the driving scenario 104 may represent a real-world driving scenario in this example, similar or identical driving scenarios may be stored (e.g., as log data) and used to execute driving simulations within a simulation system. For example, the vehicle 102 may collect log data may be based at least in part on sensor data received at the vehicle, perception data generated by a perception component on the vehicle, and/or instructions generated by a planning component of the vehicle. The vehicle 102 then may transmit the log data to a remote computing device (not illustrated in FIG. 1), which can use the log data to execute various log-based simulations corresponding to the driving scenario 104. Thus, in various examples, the driving scenario 104 may represent either a real-world or simulated driving scenario.

In some instances, the autonomous the vehicle 102 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 102 may be a fully or partially autonomous vehicle having any other level or classification. It is contemplated that the techniques discussed herein may apply to more than robotic control, such as for autonomous vehicles. For example, the techniques discussed herein may be applied to mining, manufacturing, augmented reality, etc. Moreover, even though the vehicle 102 is depicted as a land vehicle, vehicle 102 may be a spacecraft, watercraft, and/or the like. In some examples, vehicle 102 may be represented in a simulation as a simulated vehicle, such as a vehicle representation in a simulated driving scenario. For simplicity, the discussion herein does not distinguish between a simulated vehicle and a real-world vehicle. References to a “vehicle” may therefore reference a simulated and/or a real-world vehicle.

In various examples, the vehicle 102 may receive sensor data from sensor(s) 108 of the vehicle 102. For example, the sensor(s) 108 may include a location sensor (e.g., a global positioning system (GPS) sensor), an inertia sensor (e.g., an accelerometer sensor, a gyroscope sensor, etc.), a magnetic field sensor (e.g., a compass), a position/velocity/acceleration sensor (e.g., a speedometer, a drive system sensor), a depth position sensor (e.g., a lidar sensor, a radar sensor, a sonar sensor, a time of flight (ToF) camera, a depth camera, and/or other depth-sensing sensor), an image sensor (e.g., a camera), an audio sensor (e.g., a microphone), and/or environmental sensor (e.g., a barometer, a hygrometer, etc.). In examples relating to simulations, simulated sensors of a simulated vehicle may correspond with at least one of the sensor(s) 108 on the vehicle 102, and in simulations one or more of sensor(s) 108 may be simulated sensors. In some examples, the positions of simulated sensors may correspond with the relative positions of the corresponding sensor(s) 108 to the vehicle 102.

The sensor(s) 108 may generate sensor data, which may be received by computing device(s) 110 associated with the vehicle 102. However, in other examples, some or all of the sensor(s) 108 and/or computing device(s) 110 may be separate from and/or disposed remotely from the vehicle 102 and data capture, processing, commands, and/or controls may be communicated to/from the vehicle 102 by one or more remote computing devices via wired and/or wireless networks. During a simulation, the sensor data may be simulated based at least in part on a synthetic environment generated by the simulation system.

Computing device(s) 110 may comprise a memory 112 storing a perception component 114, a planning component 116, and/or controller(s) 132. Note that, in some examples, the computing device(s) 110 may additionally or alternatively store a prediction component, map data, and/or localization component, and various other components that are described herein in more data. A prediction component may be part of the perception component 114 and may be configured to determine a predicted position, orientation, velocity, acceleration, and/or state (e.g., aperture state, blinker state) associated with an object. The localization component may comprise software and/or hardware system(s) for determining a pose (e.g., position and/or orientation) of the vehicle 102 relative to one or more coordinate frames (e.g., relative to the environment, relative to a roadway, relative to an inertial direction of movement associated with the autonomous vehicle). The localization component may output at least part of this data to the perception component 114, which may output at least some of the localization data and/or use the localization data as a reference for determining at least some of the perception data.

As described below in more detail, the perception component 114 may determine what is in the environment surrounding the vehicle 102, and the planning component 116 may determine how to operate the vehicle 102 according to information received from the localization component and/or the perception component 114. The prediction component, the localization component, the perception component 114, and/or the planning component 116 may include one or more machine-learned (ML) models and/or other computer-executable instructions.

The localization component and/or the perception component 114 may receive sensor data from the sensor(s) 108. In some examples, the localization component and/or perception component 114 may comprise a pipeline of hardware and/or software, which may include one or more GPU(s), ML model(s), Kalman filter(s), and/or the like. In some instances, the perception component 114 may determine data related to objects (or simulated objects) in the vicinity of the vehicle 102 (e.g., classifications associated with detected objects, instance segmentation(s), tracks), route data that specifies a destination of the vehicle, global map data that identifies characteristics of roadways (e.g., features detectable in different sensor modalities useful for localizing the autonomous vehicle), map data that identifies characteristics detected in proximity to the vehicle (e.g., locations and/or dimensions of the roadway, roadway classification(s) (e.g., directionality associated with a portion of the roadway, crosswalk locations, controlled intersection type, signage type and location), buildings, trees, fences, fire hydrants, and any other feature detectable in various sensor modalities), etc. The data produced by the perception component 114 may be collectively referred to as “perception data.” Once the perception component 114 has generated perception data, the perception component 114 may provide the perception data to the planning component 116. Log data collected by the vehicle 102 may comprise any and all data and/or messages generated and/or passed between components including, for example, sensor data, perception data, planner data, component status data (e.g., faults, current operating status, battery state of charge, voltage levels, etc.), commands (e.g., torques, steering angles, etc.), and/or any other data generated during operation of the vehicle.

As shown in this example, the perception component 114 may detect various objects in the driving environment of the vehicle 102, including various static and/or dynamic objects, map features, and/or roadway characteristics. For instance, the perception component 114 may detect that the vehicle 102 is proceeding toward an intersection controlled by a traffic signal 122. The perception component 114 also may detect an agent 124 waiting to perform a left turn in the intersection, and/or various additional agents/objects in the driving environment.

In some instances, the perception component 114 may generate an object detection corresponding to a detected object, which may comprise a data structure indicating various characteristics of the object. For example, the object detection may indicate a region of interest (ROI) associated with the object detection (e.g., a bounding box, mask, or other indication of a portion of sensor data associated with the object); instance segmentation; semantic segmentation; a volume or area occupied by the object; a pose (e.g., position and/or orientation); velocity; acceleration; classification (e.g., vehicle, pedestrian, articulating vehicle, signage); track; confidence score(s) that any such data is accurate; etc. associated with the object. The perception component 114 may associate an object detection with a track, which may indicate that the object has been previously detected and may comprise historical perception data and/or predicted perception data associated with the object. For example, the track may associate one or more object detections associated with the same object but different times. In some examples, the track may indicate a current, historical, and/or predicted position, orientation, velocity, acceleration, and/or state associated with an object.

In some examples, the perception component 114 may comprise a prediction component that determines predicted data associated with an object, such as a predicted future position, orientation, velocity, acceleration, state, or the like. This predicted data and/or historical data associated with an object may be amalgamated with the current object detection data as a track in association with the object. In some examples, the prediction data may be additionally or alternatively based at least in part on map data or other data. In some examples, the prediction data may comprise a top-down segmentation of the environment, as described in more detail in U.S. Pat. No. 10,649,459, filed Apr. 26, 2018, which is incorporated by reference in its entirety for all purposes herein, and/or a top-down prediction associated with the environment, as described in more detail in U.S. Patent Application Publication No. 2021/0181758, filed Jan. 31, 2020, which is incorporated by reference in its entirety for all purposes herein. In some examples, the prediction data generated by such a prediction component may be part of the perception data.

The planning component 116 may determine a trajectory 120 for the vehicle 102 to follow, based at least in part on the perception data and/or localization data (e.g., where the vehicle 102 is in the environment relative to a map and/or features detected by the perception component 114). For example, the planning component 116 may determine a route for the vehicle 102 from a first location to a second location; generate, substantially simultaneously and based at least in part on the perception data, a plurality of potential trajectories for the controlling motion of the vehicle 102 in accordance with a receding horizon technique (e.g., 1 micro-second, half a second, 4 seconds, 8 seconds, and the like) to control the vehicle to traverse the route (e.g., in order to avoid any of the detected objects); and select one of the potential trajectories as a trajectory 120 that the vehicle 102 may use to generate a drive control signal that may be transmitted to drive components of the vehicle 102.

FIG. 1 depicts an example of such a trajectory 120, represented as an arrow indicating a position, heading, velocity, and/or acceleration, although the trajectory itself may comprise instructions for a controller, which may, in turn, actuate a drive system of the vehicle 102. In some examples, the trajectory 120 may comprise a sequence of waypoints defining the anticipated future states of the vehicle 102 (e.g., vehicle positions, orientations, accelerations, velocities, yaws, steering angles, etc.) at a sequence of future time points in the driving scenario. Additionally or alternatively, the trajectory 120 may comprise instructions for the controller(s) 126 of the vehicle 102 to actuate drive components of the vehicle 102 to effectuate a steering angle and/or steering rate, which may result in a subsequent vehicle state (e.g., vehicle position, vehicle orientation, vehicle velocity, and/or vehicle acceleration, etc.). In some cases, the trajectory 120 may comprise a target heading, target steering angle, target steering rate, target position, target velocity, and/or target acceleration for the controller(s) to track over a time horizon (e.g., 5 milliseconds, 10 milliseconds, 100 milliseconds, 200 milliseconds, 0.5 seconds, 1 second, 2 seconds, etc.) or a distance horizon (e.g., 1 meter, 2 meters, 5 meters, 8 meters, 10 meters). In simulated driving scenarios, the trajectory may be used by a simulation system to control a position, orientation, velocity, acceleration, etc. of the simulated autonomous vehicle.

As shown in this example, the trajectory 120 determined by the planning component 116 may be a trajectory causing the vehicle 102 to pass through the intersection controlled by the traffic signal 122. In such scenarios, the planning component 116 may use parameters 118 (e.g., traffic signal parameters) to compute costs associated with the trajectory 120 relating to moving through the intersection when the traffic signal 122 is in a non-permissible state (e.g., displaying a red light). To compute the traffic signal costs, the planning component 116 may use parameters 118 to parameterize one or more traffic signal cost functions (e.g., junction entry and/or junction blocking cost functions), and then apply the traffic signal cost functions to the trajectory as it passes through the intersection. As noted above, these traffic signal costs may be combined and/or aggregated with various other cost types (e.g., safety costs, passenger experience costs, driving route efficiency costs, etc.), and used to determine a particular trajectory 120 as the optimal trajectory for the vehicle 102 to follow.

For instance, if the traffic signal 122 were to change from green to yellow at the point in time depicted in FIG. 1, the planning component 116 would use the parameters 118 to calculate traffic signal costs for any potential trajectory that would cause the vehicle to enter and/or occupy the intersection while the traffic signal 122 is anticipated to be in a non-permissible state (e.g., a red light). Based on the traffic signal costs of the different potential trajectories, as well as additional costs (e.g., safety costs, passenger experience costs, traffic rules conformance costs, etc.) associated with the potential trajectories, the planning component 116 may select an optimal (e.g., lowest cost) trajectory 120 for the vehicle 102. In one example, based on the traffic signal costs and/or additional costs, the planning component 116 may select an optimal trajectory 120 that causes the vehicle 102 to stop before reaching the intersection. In other examples, based on different traffic signal costs (and/or additional costs), the planning component 116 may select a different optimal trajectory 120 that causes the vehicle 102 to drive through the intersection. For instance, the planning component 116 may select an optimal trajectory 120 that causes the vehicle 102 to speed up slightly in order to safely clear the intersection before the traffic signal 122 turns red. In other instances, the planning component 116 may select an optimal trajectory 120 that causes the vehicle 102 to speed up slightly in order to safely clear the intersection before the traffic signal 122 turns red. In other instances, the optimal trajectory 120 may cause the vehicle 102 to maintain speed or slow down while driving through the intersection, which may incur a traffic signal cost (e.g., occupying the cross-traffic lanes of the intersection while the traffic signal 122 is red), but nonetheless may be preferable to an alternative trajectory that stops before the intersection and risks a rear-impact collision from a following vehicle.

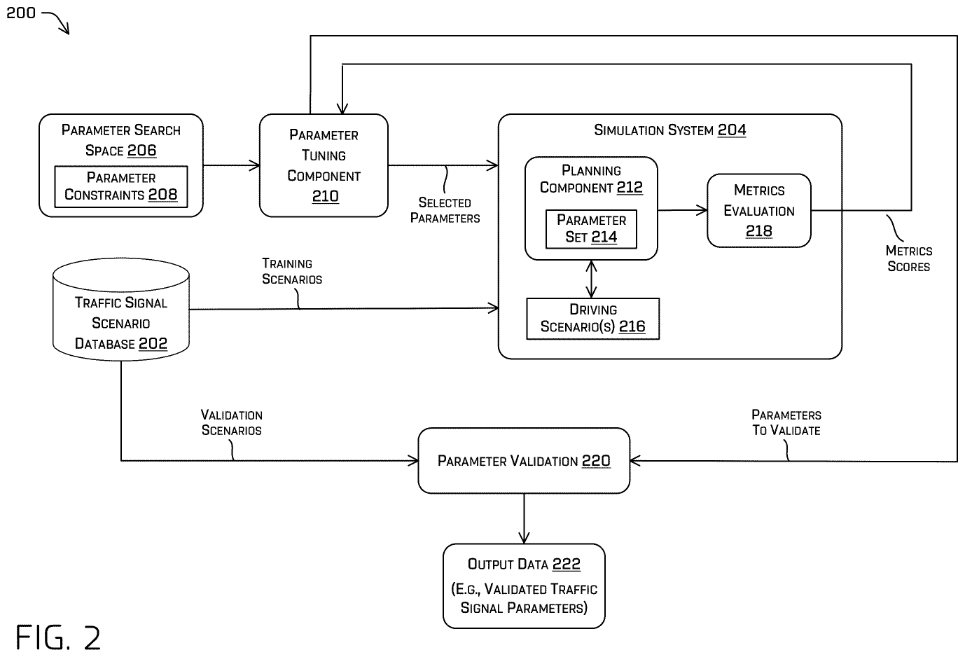

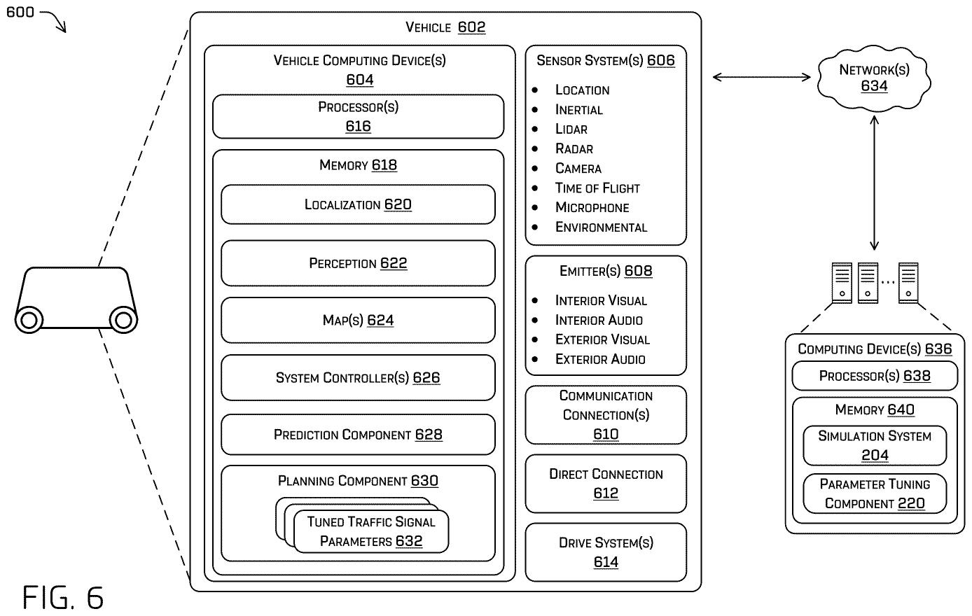

FIG. 2 illustrates a block diagram of an example parameter tuning system 200 for implementing techniques to modify sets of traffic signal parameters as described herein. In some examples, the parameter tuning system 200 may be implemented using one or more computing device(s) remote and separate from a vehicle, such as computing devices (2) 636 in FIG. 6. However, the output data 222 from the parameter tuning system 200 may include data representing one or more sets of traffic signal parameters for operating one or more components of the vehicle 102. For instance, the output data 222 may be provided to one or more autonomous vehicles (e.g., vehicle 102) and used by planning components on the autonomous vehicles to control the vehicles in driving scenarios including traffic signal-controlled intersections. Additionally or alternatively, the parameter tuning system 200 may be implemented by a vehicle 102 (e.g., within the computing device(s) 110), in which case the planning component 116 may be configured to retrieve and update parameters 118 based on the output data 222.

As shown in this example, the output data 222 of the parameter tuning system 200 may include a set of validated traffic signal parameters. Additionally or alternatively, the parameter tuning system 200 may be used to output various different parameters used by the planning component 116 for controlling the vehicle 102, including but not limited to vehicle collision or safety cost parameters, passenger experience cost parameters, traffic rule conformance cost parameters, driving route efficiency cost parameters, etc. Additionally, in at least one example, the parameter tuning system 200 may be implemented using the computer architectures, techniques, and/or features described in detail in U.S. patent application Ser. No. 17/897,111, filed Aug. 26, 2022, and entitled, “Automatic Parameter Determination System,” the entire contents of which are incorporated herein by reference in their entirety for all purposes.

The parameter tuning system 200 may include a database 202 for storing various traffic signal driving scenarios. As discussed above, driving scenarios may be based on snippets of log data collected by a vehicle while traversing a driving environment (e.g., real or simulated) for a time period. Traffic signal driving scenarios may refer to driving scenarios in which the ego vehicle (e.g., the vehicle that collected the log data) approaches or passes through an intersection at a time when a traffic signal controlling the intersection changes from a permissible state (e.g., a green or yellow light) to a non-permissible state (e.g., a red light). A particular scenario in the database 202 may, for example, represent the driving scenario 104 described above. The driving scenarios in database 202 may be used as training scenarios to tune the traffic signal parameters, thereby improving driving behaviors within similar traffic signal driving scenarios encountered in real-world driving environments. Accordingly, the database 202 may be designed to include a large number of robust and varying driving scenarios that represent different close-call driving decisions (e.g., go-no-go) at controlled intersections, including scenarios at different types of controlled intersections, having different numbers and configurations of agents, road conditions, etc.

The simulation system 204 may include components configured to execute driving simulations based on various driving scenarios in the database 202, in order to test and validate sets of traffic signal parameters (e.g., parameter set 214) being used by the planning component 212. When executing a log-based simulation based on a traffic signal driving scenario, the simulation system 204 may be configured to provide portions of the log data representing the driving scenario (e.g., sensor data, map data, localization data perception data, planning data, etc.) to one or more autonomous vehicle components being evaluated (e.g., planning component 212), and to receive and evaluate outputs from the autonomous vehicle components during the driving simulation. During a log-based simulation, the simulation system 204 may generate a simulated driving environment comprising simulated objects such as map features, agents and static objects, buildings, signage, road debris, etc. The simulation system 204 then may provide respective parts of the driving scenario 216 to the respective autonomous driving components as part of the simulation. The simulation system 204 then may observe and record the driving behaviors of the simulated vehicle (e.g., corresponding to the ego vehicle) being controlled by the planning component 212 during the simulation. Additionally, although only the planning component 212 is shown within the simulation system 204 in this example, in other examples any or all of the additional autonomous vehicle components may be executed in the driving simulations described herein (e.g., simulated sensors, simulated perception, localization, and prediction components, etc.).

For the initial iteration of selecting a parameter set (e.g., before any metrics are received from the simulation system 204), the parameter tuning component 210 may receive data representing the parameter search space 206, which may include the specific set of parameters to be tuned (e.g., parameter names/identifiers, types, and/or value ranges of each parameter). Although certain examples herein describe traffic signal parameters with numeric (e.g., floating point) types, in other examples, the parameters to be tuned by the parameter tuning system 200 may include parameters in format types including but not limited to floating point numbers, integer, Boolean values, strings, time formats, etc. One or more of the parameters to be tuned by the parameter tuning system 200 may include parameter constraints 208, such as range constraints that identify particular regions within the parameter search space 206 that should and/or should be searched with respect to the constrained parameter. Based on the selected traffic signal parameters to be tuned (which may include all or any subset of the traffic signal parameters), the parameter search space 206, and any applicable parameter constraints 208, the parameter tuning component 210 may select a candidate set of traffic signal parameters to be evaluated. As shown in this example, the selected candidate set of traffic signal parameters may be provided to the simulation system 204 and used by the planning component 212 when executing simulations based on driving scenario(s) 216. In the first/initial iteration of parameter selection, the parameter tuning component 210 may be configured to determine a search space configuration that identifies a name, upper bounds, lower bounds, and/or whether to “warm-start” a parameter search (e.g., use previous parameter scores to determine new candidate parameters), and may determine the initial candidate set of parameters (and/or subsequent candidate sets) based on the search space configuration. In various examples, the initial set of parameters may be determined based on random selection, human-provided parameter suggestion, and/or predetermined or human-provided exploration strategies for exploring the search space (e.g., designed to maximize the information that can be obtained from one or more preselected parameter sets.

As shown in this example, the simulation system 204 may retrieve and execute a set of traffic signal scenario(s) 216 from the database 202, wherein the simulation is based at least in part on the candidate parameter set 214 selected by the parameter tuning component 210. In some examples, multiple driving scenario(s) 216 can be executed in parallel by a distributed simulation system and/or cloud computing platform/infrastructure.

The simulation system 204 may include a metrics evaluation component 218 configured to evaluate the parameter set 214 used by the simulation system 204 when executing a set of training scenarios. In some examples, the metrics evaluation component 218 may evaluate the driving behaviors and/or trajectories of the simulated vehicle within the driving simulations, using a set of performance metrics measuring desirable or undesirable driving behaviors with respect to traffic signal intersections. The performance metrics described herein may include metrics based on any combination of costs associated with desirable or undesirable driving behaviors, including the various examples of costs and related features described in detail in U.S. patent application Ser. No. 18/844,419, filed Dec. 19, 2022, and entitled, “Machine-Learned Cost Estimation In Tree Search Trajectory Generation For Vehicle Control,” the entire contents of which are incorporated herein by reference in their entirety for all purposes. For example, certain performance metrics used by the metrics evaluation component 218 may be based on the amount of time in a simulation between when the simulated vehicle (e.g., the vehicle controlled by the planning component 212 based at least in part on the parameter set 214) enters the intersection, relative to when the traffic signal changes to red. Score values for such performance metric may be positive or negative, with higher scores representing more desirable driving behavior. In other examples, performance metric used by the metrics evaluation component 218 may measure the amount of time in the driving simulation that the simulated vehicle occupies a cross-traffic lane in the intersection after the traffic signal has changed to red. Score values for such performance metrics may be zero or positive, with lower scores representing more desirable driving behavior. Additional different performance metrics may be used to evaluate the behaviors of the simulated vehicle in the training scenarios relating to traffic signals, such as performance metrics based on the speed of the vehicle while driving through an intersection displaying a yellow or red light, the curve of the driving path the vehicle takes turning in an intersection displaying a yellow or red light, and/or metrics for measuring other types of desirable or undesirable driving behaviors.

In some examples, the metrics evaluation component 218 may determine a score representing how well the parameter set 214 performed in each of the driving scenario(s) 216, and/or may combine or aggregate these scores to determine a single score representing the overall driving performance associated with the parameter set 214 across the complete set of training scenarios in the database 202. In some examples, the metrics evaluation component 218 may different scores representing how well the parameter set 214 performed in a variety of scenario types/clusters (e.g., scenarios with different types of intersections, crowded scenarios (e.g., having a large number of agents) versus sparse scenarios, scenarios on roadways having different speed limits, scenarios in different types of weather or traffic conditions, and so on).

In some examples, the metrics evaluation component 218 can apply an objective function to generate the overall score representing a level of performance for the parameter set 214. The objective function may determine whether the set of parameters satisfies a particular threshold with respect to driving behaviors in controlled intersections. For example, the metrics evaluation component 218 can assign higher scores to parameter sets that have higher averages or aggregated scores for the performance metrics. Such scores may additionally or alternatively be based on, for example, adherence to rules or policies, additional types of costs associated with the various trajectories, an aggregate number of collisions or performances relative to other systems or human performance, and the like, including any combination thereof.

For subsequent iterations of selecting parameter sets (e.g., after receiving metrics from the simulation system 204), the parameter tuning component 210 may be configured to receive the scores from the metrics evaluation component 218 associated with particular parameter sets, and to output proposed modified sets of traffic signal parameters. As described below in more detail, the parameter tuning component 210 may include various search and/or optimization algorithms to predict new/modified parameter sets that are likely to improve the traffic signal performance metrics when used across the database 202 of training scenarios. As additional data is received for different parameter sets, the parameter tuning component 210 may adjust its parameter set predictions over time. As shown in FIG. 2, the modified parameters determined by the parameter tuning component 210 may be provided to the simulation system 204 to be used as a subsequent parameter set 214 to be evaluated. In some examples, an output by the parameter tuning component 210 can be used as input (or pre-processed for use as the input) by other components (not depicted in FIG. 2) to configure, test, and/or validate that the modified parameters will be usable to control a vehicle. In some examples, the parameter tuning component 210 may include one or more machine-learned models trained to output parameter sets, search and/or optimization algorithms (including stochastic searches), objective functions, and the like as otherwise described in detail herein.

In various examples, the parameter tuning component 210 may apply an algorithm (e.g., an optimization function (Bayesian, gradient-free optimization, a third-party optimization library, etc.), a multi-objective function, an acquisition function, an inverse reinforcement learning function, a grid search parameter sweep, etc.) to a set of parameters based at least in part on the scores output by metrics evaluation component 218 (and/or the parameter search space 206 and parameter constraints 208) to determine the proposed set of parameters for training, validation, and so on. In some examples, the parameter tuning component 210 can store scores for different sets of parameters in the database 202. In various examples, the parameter tuning component 210 can send the proposed parameters to a validation component 220 for validation, based at least in part on the set of proposed parameters having metrics score above a score threshold and/or higher than another candidate set of parameters.

The validation component 220 may be configured to validate a set of traffic signal parameters received from the parameter tuning component 210, based on driving scenarios from the database 202 and/or based on independent validation processes. In some examples, validation component 220 may execute one or more validation scenarios using the set of parameters to validate and may compare various results/benchmarks from the validation scenarios to a set of objectives and/or constraints (e.g., a safety constraint, distance constraint, a violation of traffic law constraint, a progress constraint, a passenger experience constraint, etc.). In examples when the set of traffic signal parameters to validate performs at or above the performance threshold (e.g., indicating no or minimal regression of driving behaviors with respect to safety metrics, passenger experience metrics, etc., then the validation component 220 may provide the output data 222 comprising the modified/improved set of traffic signal parameters for deployment to one or more vehicles 102. In examples when a set of parameters to validate performs below a performance threshold (e.g., regresses a safety metric), the validation component 220 may refrain from deploying the proposed set of parameters in the output data 222.

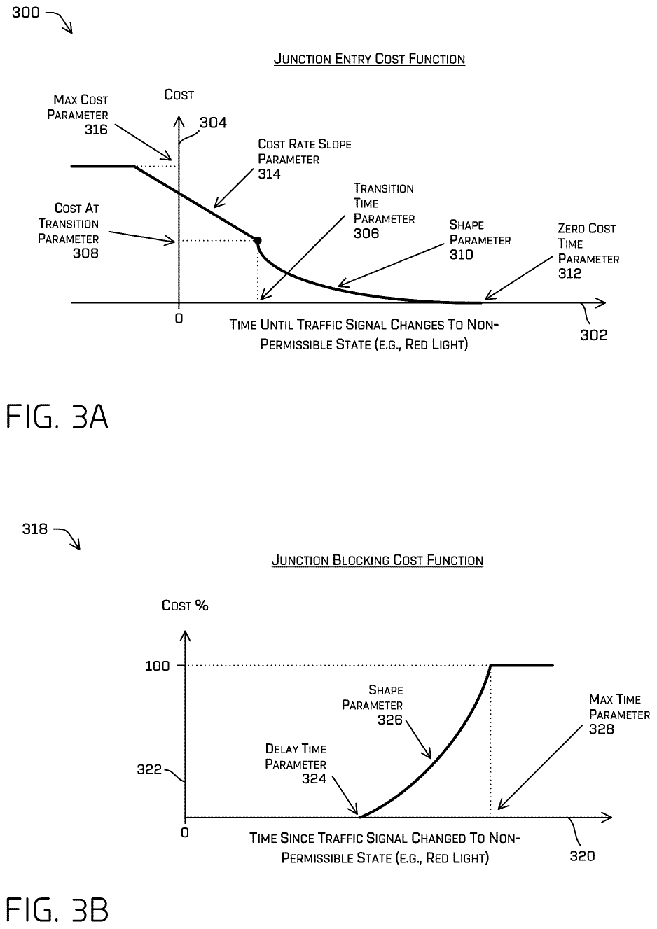

FIG. 3A and FIG. 3B depict graphs representing two examples of traffic signal cost functions that may be executed by a vehicle 102 to assist in controlling the vehicle in and near intersections controlled by traffic signals. In this example, FIG. 3A and FIG. 3B respectively illustrate a junction entry cost function 300 and a junction blocking cost function 318 that may be executed by a planning component 116 of the vehicle 102 to compute costs for evaluating potential trajectories of the vehicle. In this example, the junction entry cost function 300 may be executed to determine costs associated with a trajectory when the trajectory causes the vehicle to enter an intersection at a time when the traffic signal is or soon will be in a stop state (e.g., displaying a red light). The junction blocking cost function 318 may be executed to determine costs associated with a trajectory that causes the vehicle to occupy an intersection at a time when the traffic signal is in a stop state (e.g., displaying a red light), when the vehicle may potentially be blocking other vehicles in a cross-traffic lane.

Both of these cost functions in these examples are parameterized functions that can be tuned by adjusting one or more of the parameters. Modifications to any of the parameters of the junction entry cost function 300 or the junction blocking cost function 318 may change the traffic signal costs that planning component 116 computes for a trajectory, which may potentially change whether or not that trajectory is selected by the planning component 116 as the optimal trajectory for the vehicle 102 to follow.

In this example, the junction entry cost function 300 is shown on a graph having a time axis 302 and a cost axis 304. The time shown in the time axis 302 may represent the amount of time from the current time until when the planning component 116 anticipates that the traffic signal will turn red. Thus, the time may be positive to indicate that the signal has not yet turned red, or negative to indicate that the signal has already turned red. To compute the junction entry cost, the planning component 116 may be configured to estimate the future time when a yellow traffic signal will change to red, which may be based on preconfigured settings, previous observations by the vehicle, and/or municipal or traffic authority data sources, etc. As shown in this example, the junction entry cost generally decreases as the amount of time until the signal will change to red increases. However, the decreasing cost is not uniform. The junction entry cost function 300 is designed as multiple separate and joined functions, in which the individual functions and the transitions between the functions may be tuned by parameters. In this case, a transition time parameter 306 may define a time (relative to the time when the signal will turn red) when the junction entry cost function 300 switches from a linear function to a quadratic decay function. At the transition time, the junction entry cost function 300 defines a cost using a corresponding cost parameter 308. To the right of the transition time, the junction entry cost is computed using a quadratic decay function based on a shape parameter 310, the cost terminating at a zero cost time parameter 312. To the left of the transition time, the junction entry cost is computed using a linear function based on a cost rate slope parameter 314, until the cost reaches a maximum value defined by a maximum cost parameter 316. Of course, any other functions are contemplated (e.g., linear, exponential decay, polynomial, etc.).

The junction blocking cost function 318 is also shown on a graph having a time axis 320 and a cost percentage axis 322. The time shown in the time axis 320 may represent the amount of time since the traffic signal has changed to red. As shown in this example, the junction blocking cost generally increases as the amount of time since the signal has changed to red increases. However, as in the previous example, the increasing cost is not uniform but is based on multiple joined functions and/or parameters. In this example, a delay time parameter 324 may define the time (after the signal changed to red) when a quadratic cost function is applied. After the delay time has been reached, the junction blocking cost is computed using a cost curve function (e.g., linear, exponential decay, quadratic, polynomial, etc.) based on another shape parameter 326, until a maximum time is reached defined by a maximum time parameter 328.

As these examples illustrate, the complexity of the traffic signal cost functions and the number of parameters used may result in a relatively large parameter search space, and in complex and obscure relationships between parameter sets and performance metrics. As a result, tuning and optimization of the parameter sets of junction entry cost function 300 and junction blocking cost function 318 may be unsuitable and/or infeasible via manual tuning.

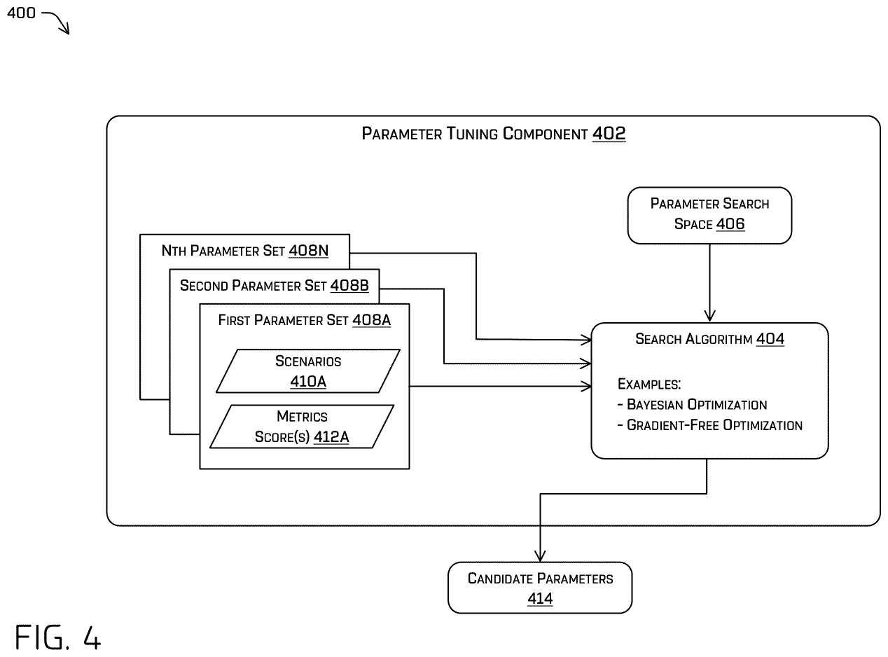

FIG. 4 illustrates an example 400 of a parameter tuning component 402 configured to determine sets of traffic signal parameters usable to control a vehicle 102 in and around traffic signal-controlled intersections. For example, the parameter tuning component 210 described in FIG. 2 may include some or all aspects of the parameter tuning component 402 described in this example.

As shown in FIG. 4, the parameter tuning component 402 may execute one or more search algorithms 404, based on a parameter search space 406 (e.g., including any range constraints) and previous sets of performance metrics scores 412 associated with parameter sets 408 used during execution of various training scenarios 410A to 410N. In this example, the parameter tuning component 402 may receive data associated with previous sets of driving simulations executed by the simulation system 204 using various parameter sets 408A to 408N. For each set of driving simulations, the parameter tuning component 402 may receive data relating to the parameter set used by the simulation system 204 when performing the simulations, the scenarios 410 on which the simulations were based, and the corresponding metrics score(s) 412 determined based on the simulation results/outcomes (e.g., determined by the metrics evaluation component 218).

In some examples, the parameter tuning component 402 also may receive user-specified configuration data that can be used to constrain or guide the search algorithm 404 within the parameter search space 406. Additionally or alternatively, the parameter tuning component 402 may receive user-specified data identifying a subset of the training scenarios in the database 202, which may be used to determine metrics scores 412 associated with the selected subset of training scenarios.

As discussed above, the metric score(s) 412 may represent how well a parameter set 410 of traffic signal parameters performed with respect to traffic signal-related behaviors during the set of driving simulations. In some examples, metric score(s) 412 also may include scores associated with additional performance metrics, including various metrics related to any combination of vehicle safety, route progress or efficiency, passenger comfort, conformance with the rules of the road, etc. In examples when the metrics scores 412 meet or exceed a threshold, the parameter tuning component 402 may determine that tuning is complete and parameter set 408 can be output as candidate parameters 414 for validating and testing. The candidate parameters 414 may represent a set of traffic signal parameters that are usable for a planning component and/or driving algorithm to determine actions for the vehicle 102 in and around intersections controlled by traffic signals in non-permissible states.

In examples when the metrics scores 412 determined for a parameter set 408 is below a score threshold, the parameter tuning may continue may determining one or more additional parameter sets 408 to test and evaluate against the set of driving scenarios 410. In some cases, data representing the parameter sets 408 and the corresponding metrics scores 412 associated with the parameter sets 408 may be used as feedback data to the search algorithm 404, which may be configured to adjust, alter, or modify the parameter sets 408 for use in a subsequent set of scenarios. In such examples, the parameter tuning component 402 may provide the modified parameters (and/or listing of scenarios to execute from the training scenarios) to the simulation system 204, and then may subsequently determine a second set of metrics scores 412 representing the performance of the modified parameter set. In some cases, the parameter tuning component 402 may use heuristics to component the metrics scores 412 associated with different parameter sets 408 and may output as the candidate parameters 414 the set of parameters associated with the highest metrics scores. In other examples, all determinations by the parameter tuning component 402 (e.g., metrics scores 412 for different parameter sets) may be sent to the validation component 220 for validating and testing.

In some examples, the parameter tuning component 402 can implement the search algorithm 404 as a distributed parameter optimization algorithm that optimizes parameters based at least in part on previous metrics scores(s) 412 and/or corresponding previous parameter sets 408. For example, the search algorithm 404 may determine a particular parameter value based at least in part on a distribution of previous sets of parameters and metrics scores. In various examples, the parameter tuning may include applying the distributed parameter optimization algorithm to optimize a parameter associated with a component or algorithm. In some examples, the search algorithm 404 can be predetermined based at least in part on a user input via a user interface indicating one or more search algorithms to implement.

Generally, the parameter tuning component 402 can provide functionality based at least in part on an API (e.g., a functional API or a class API). For example, the API can be invoked to cause an exchange of data between the database 202, the simulation system 204, the metrics evaluation component 218, the validation component 220, and/or a user interface component. For instance, data communicated between components and/or the user interface can utilize a common API to optimize data transmissions.

In some examples, prior to performing the techniques described in FIG. 4 of iteratively executing a search algorithm 404 to determine next sets of candidate parameters 414, the planning component may initially perform a grid search and filtering techniques to effectively narrow the parameter search space. For instance, an initial grid search may systematically explore the parameter search space 406 to evaluate various sets of parameters within the search space. Various filtering criteria may be applied to exclude regions in the parameters search space from subsequent searching using the search algorithm 404. For instance, the initial parameter search space may be partitioned and filtered to exclude (from the search algorithm 404) regions of the parameter search space that are determined during the grid search to include collisions or to violate safety metrics, passenger experience metrics, etc. Additional filters may be used to exclude regions from the parameter search space that include separable clusters of parameter sets that (based on the grid search results) clearly correspond to non-optimal regions of the parameter search space.

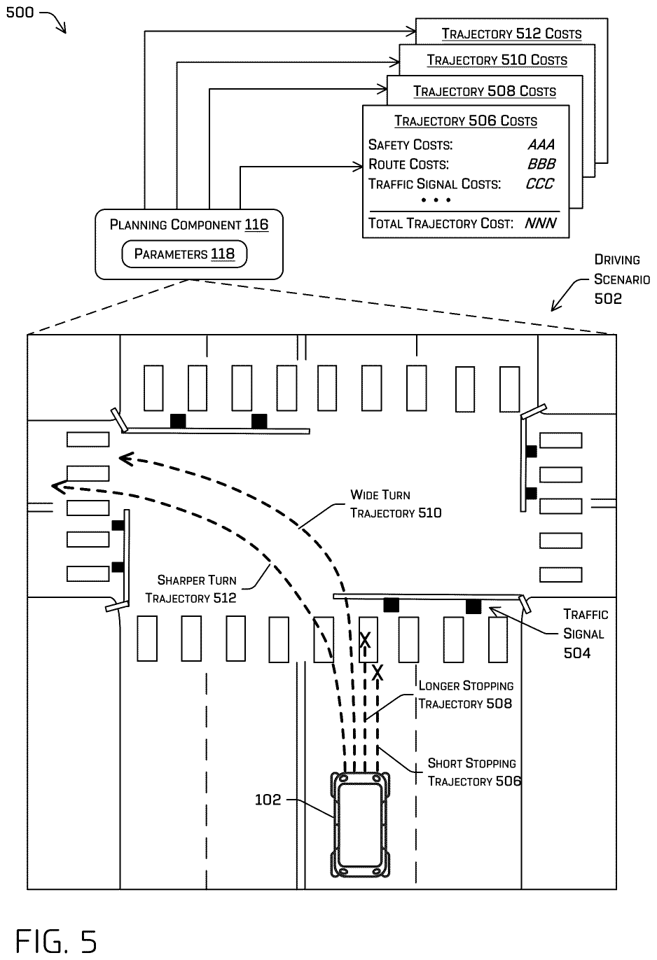

FIG. 5 shows an example diagram 500 depicting a vehicle 102 traversing a real-world driving scenario 502. In this example, the vehicle 102 may correspond to the vehicle 102 described above in reference to FIG. 1. As described above, the vehicle 102 may include a planning component 116 configured to use a set of traffic signal parameters 118 to compute costs associated with potential driving routes and/or trajectories. In particular, as described herein, the traffic signal parameters 118 may include sets of parameters applied to various traffic signal cost functions (e.g., junction entry cost function 300, junction blocking cost function 318, etc.).

Using the traffic signal parameters 118, the planning component 116 may compute traffic signal costs for any number of potential trajectories being evaluated and compared by the planning component 116 during a trajectory selection and/or optimization operation. As shown in this example, the driving scenario 502 includes a traffic signal 504 which has recently changed from green to yellow. The vehicle 102 intends to make a left turn at the intersection, and then planning component 116 has determined four potential trajectories for the vehicle with respect to the intersection. A first potential trajectory 506 may cause the vehicle to perform a relatively quick deceleration in response to the changed traffic signal 504, resulting in the vehicle stopping before the crosswalk in front of the intersection. A second potential trajectory 508 may cause the vehicle to perform a less rapid deceleration, resulting in the vehicle stopping in the crosswalk in front of the intersection. A third potential trajectory 510 may cause the vehicle to proceed through the intersection while the traffic signal 504 is in a stop state (e.g., displaying a red light), using a slower speed and a wider turn. A fourth potential trajectory 512 may cause the vehicle to proceed through the intersection while the traffic signal 504 is in a stop state but using a faster speed and a sharper turn. Although only four potential trajectories are shown in this example, in other examples the planning component 116 (and/or other driving algorithms on the vehicle 102 may determine and evaluate any number of potential trajectories).

In some examples, the planning component 116 may use a tree search algorithm, based on costs, to determine the optimal (e.g., lowest-cost) trajectory for controlling the vehicle, including features and techniques described in more detail in U.S. patent application Ser. No. 18/392,114, filed Dec. 21, 2023, and titled, “Machine-Learned Candidate Action Selection in Tree Search,” U.S. patent application Ser. No. 17/394,334, filed on Aug. 4, 2021, and titled, “Vehicle Trajectory Control Using A Tree Search,” U.S. patent application Ser. No. 17/351,641, filed Jun. 18, 2021, and titled, “Active Prediction Based On Object Trajectories,” and/or U.S. patent application Ser. No. 17/855,088, filed Jun. 30, 2022, and titled, “Machine-Learned Component For Vehicle Trajectory Generation,” the entire contents of each of which are incorporated herein by reference in their entirety for all purposes.

As shown in this example, the planning component 116 may compute and aggregate various costs for each of the potential trajectories 506-512. The traffic signal costs may be based on the results of one or more cost functions (e.g., junction entry cost function 300, junction blocking cost function 318), which the planning component 116 may use the parameters 118 to execute. Additionally, the planning component 116 may use additional cost functions (e.g., heuristic and/or ML-based) and/or additional parameters to compute additional costs, such as various costs that may be classified as collision costs, vehicle safety costs, driving route costs, passenger experience costs, rule conformance costs, and/or the like. As shown in this example, based on the aggregation of these costs, the planning component 116 may select a particular driving trajectory as the optimal trajectory for the vehicle 102 to approach and/or traverse the intersection. Thus, as described herein, different modified and/or tuned values of the traffic signal parameters 118 may result in different traffic signal costs computed by the planning component 116, which may cause the vehicle 102 to select a different trajectory.

FIG. 6 depicts a block diagram of an example system 600 for implementing various techniques described herein. In some instances, the example system 600 may include a vehicle 602, which may represent the vehicle 102 discussed above in FIG. 1-5. In some instances, the vehicle 602 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 602 may be a fully or partially autonomous vehicle having any other level or classification. Moreover, in some instances, the techniques described herein may be usable by non-autonomous vehicles as well. These are merely examples, and the systems and methods described herein also may be incorporated into any ground-borne, airborne, or waterborne vehicle, including those ranging from vehicles that need to be manually controlled by a driver at all times, to those that are partially or fully autonomously controlled.

The vehicle 602 can be configured to perform various techniques described herein, including storing one or more sets of traffic signal parameters 118 which may be deployed within the vehicle 602 and used by the planning component 116 to control the driving behaviors and/or trajectory optimization while operating in and around traffic signal-controlled intersections. In some examples, the vehicle 602 also may be configured to provide log data to one or more separate computing devices 636, such as log data of real-world traffic signal driving scenarios which may be stored and used as training scenarios within database 202.

The vehicle 602 may include vehicle computing device(s) 604, sensor(s) 606, emitter(s) 608, network interface(s) 610, at least one direct connection 612 (e.g., for physically coupling with the vehicle to exchange data and/or to provide power), and one or more drive system(s) 614. In this example, the vehicle 602 may correspond to vehicle 102 discussed above. The system 600 may additionally or alternatively comprise computing device(s) 604.

In some instances, the sensor(s) 606 may include lidar sensors, radar sensors, ultrasonic transducers, sonar sensors, location sensors (e.g., global positioning system (GPS), compass,), inertial sensors (e.g., inertial measurement units (IMUs), accelerometers, magnetometers, gyroscopes,), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors,), etc. The sensor(s) 606 may include multiple instances of each of these or other types of sensors. For instance, the radar sensors may include individual radar sensors located at the corners, front, back, sides, and/or top of the vehicle 602. As another example, the cameras may include multiple cameras disposed at various locations about the exterior and/or interior of the vehicle 602. The sensor(s) 606 may provide input to the vehicle computing device(s) 604 and/or to computing device(s) 636.

The vehicle 602 may also include emitter(s) 608 for emitting light and/or sound, as described above. The emitter(s) 608 in this example may include interior audio and visual emitter(s) to communicate with passengers of the vehicle 602. By way of example and not limitation, interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 608 in this example may also include exterior emitter(s). By way of example and not limitation, the exterior emitter(s) in this example include lights to signal a direction of travel or other indicator of vehicle action (e.g., indicator lights, signs, light arrays,), and one or more audio emitter(s) (e.g., speakers, speaker arrays, horns,) to audibly communicate with pedestrians or other nearby vehicles, one or more of which comprising acoustic beam steering technology.

The vehicle 602 may also include network interface(s) 610 that enable communication between the vehicle 602 and one or more other local or remote computing device(s). For instance, the network interface(s) 610 may facilitate communication with other local computing device(s) on the vehicle 602 and/or the drive systems(s) 614. Also, the network interface(s) 610 may additionally or alternatively allow the vehicle to communicate with other nearby computing device(s) (e.g., other nearby vehicles, traffic signals, etc.). The network interface(s) 610 may additionally or alternatively enable the vehicle 602 to communicate with computing device(s) 636. In some examples, computing device(s) 636 may comprise one or more nodes of a distributed computing system (e.g., a cloud computing architecture).

The network interface(s) 610 may include physical and/or logical interfaces for connecting the vehicle computing device(s) 604 to another computing device or a network, such as network(s) 634. For example, the network interface(s) 610 may enable Wi-Fi-based communication such as via frequencies defined by the IEEE 200.11 standards, short range wireless frequencies such as Bluetooth®, cellular communication (e.g., 2G, 3G, 4G, 4G LTE, 5G, etc.) or any suitable wired or wireless communications protocol that enables the respective computing device to interface with the other computing device(s). In some instances, the vehicle computing device(s) 604 and/or the sensor(s) 606 may send sensor data, via the network(s) 634, to the computing device(s) 636 at a particular frequency, after a lapse of a predetermined period of time, in near real-time, etc.

In some instances, the vehicle 602 may include one or more drive systems(s) 614 (or drive components). In some instances, the vehicle 602 may have a single drive system 614. In some instances, the drive system(s) 614 may include one or more sensors to detect conditions of the drive system(s) 614 and/or the surroundings of the vehicle 602. By way of example and not limitation, the sensor(s) of the drive systems(s) 614 may include one or more wheel encoders (e.g., rotary encoders) to sense rotation of the wheels of the drive components, inertial sensors (e.g., inertial measurement units, accelerometers, gyroscopes, magnetometers) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive systems(s) 614. In some cases, the sensor(s) on the drive systems(s) 614 may overlap or supplement corresponding systems of the vehicle 602 (e.g., sensor(s) 606).‘

The drive systems(s) 614 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive systems(s) 614 may include a drive component controller which may receive and preprocess data from the sensor(s) and to control operation of the various vehicle systems. In some instances, the drive component controller may include one or more processors and memory communicatively coupled with the one or more processors. The memory may store one or more components to perform various functionalities of the drive systems(s) 614. Furthermore, the drive systems(s) 614 may also include one or more communication connection(s) that enable communication by the respective drive component with one or more other local or remote computing device(s).

The vehicle computing device(s) 604 may include processor(s) 616 and memory 618 communicatively coupled with the one or more processors 616. Computing device(s) 636 may also include processor(s) 638, and/or memory 640. As described above, the memory 640 of the computing device(s) 636 may store and execute a simulation system 204 and/or a parameter tuning component 210, which may be similar or identical to the corresponding components described above in reference to FIG. 2 and may be configured to perform any combination of scenario simulation execution, metrics evaluation, and/or parameter tuning, functionality described herein.

The processor(s) 616 and/or 638 may be any suitable processor capable of executing instructions to process data and perform operations as described herein. By way of example and not limitation, the processor(s) 616 and/or 638 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 618 and/or 640 may be examples of non-transitory computer-readable media. The memory 618 and/or 640 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 618 and/or memory 640 may store a localization component 620, perception component 622, maps 624, system controller(s) 626, prediction component 628, and/or planning component 630. As shown in this example, the planning component 630 may include one or more sets of tuned (e.g., improved or optimized) traffic signal parameters 632, which the planning component 630 may use to control the driving behaviors and/or trajectory optimization of the vehicle 602 around intersections controlled with traffic signals.

In at least one example, the localization component 620 may include hardware and/or software to receive data from the sensor(s) 606 to determine a position, velocity, and/or orientation of the vehicle 602 (e.g., one or more of an x-, y-, z-position, roll, pitch, or yaw). For example, the localization component 620 may include map(s) of an environment and can continuously determine a location, velocity, and/or orientation of the autonomous vehicle within the map(s). In some instances, the localization component 620 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 620 may provide data to various components of the vehicle 602 to determine an initial position of an autonomous vehicle for generating a trajectory and/or for generating map data, as discussed herein. In some examples, localization component 620 may provide, to the planning component 630 and/or to the prediction component 628, a location and/or orientation of the vehicle 602 relative to the environment and/or sensor data associated therewith.

The memory 618 can further include one or more maps 624 that can be used by the vehicle 602 to navigate within the environment. For the purpose of this discussion, a map can be any number of data structures modeled in two dimensions, three dimensions, or N-dimensions that are capable of providing information about an environment, such as, but not limited to, topologies (such as intersections), streets, mountain ranges, roads, terrain, and the environment in general. In one example, a map can include a three-dimensional mesh generated using the techniques discussed herein. In some instances, the map can be stored in a tiled format, such that individual tiles of the map represent a discrete portion of an environment, and can be loaded into working memory as needed. In at least one example, the one or more maps 624 may include at least one map (e.g., images and/or a mesh) generated in accordance with the techniques discussed herein. In some examples, the vehicle 602 can be controlled based at least in part on the maps 624. That is, the maps 624 can be used in connection with the localization component 620, the perception component 622, and/or the planning component 630 to determine a location of the vehicle 602, identify objects in an environment, and/or generate routes and/or trajectories to navigate within an environment.

In some instances, the perception component 622 may comprise a primary perception system and/or a prediction system implemented in hardware and/or software. The perception component 622 may detect object(s) in in an environment surrounding the vehicle 602 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. To perform these tasks, the perception component 622 may include one or more trained classifier systems. Data determined by the perception component 622 is referred to as perception data.

In some examples, sensor data and/or perception data may be used to generate an environment state that represents a current state of the environment. For example, the environment state may be a data structure that identifies object data (e.g., object position, area of environment occupied by object, object heading, object velocity, historical object data), environment layout data (e.g., a map or sensor-generated layout of the environment), environment condition data (e.g., the location and/or area associated with environmental features, such as standing water or ice, whether it's raining, visibility metric), sensor data (e.g., an image, point cloud), etc. In some examples, the environment state may include a top-down two-dimensional representation of the environment and/or a three-dimensional representation of the environment, either of which may be augmented with object data. In yet another example, the environment state may include sensor data alone. In yet another example, the environment state may include sensor data and perception data together.

The prediction component 628 may include functionality to generate predicted information associated with objects in an environment. As an example, the prediction component 628 can be implemented to predict locations of a pedestrian proximate to a crosswalk region (or otherwise a region or location associated with a pedestrian crossing a road) in an environment as they traverse or prepare to traverse through the crosswalk region. As another example, the techniques discussed herein can be implemented to predict locations of other objects (e.g., vehicles, bicycles, pedestrians, and the like) as the vehicle 602 traverses an environment. In some examples, the prediction component 628 can generate one or more predicted positions, predicted velocities, predicted trajectories, etc., for such target objects based on attributes of the target object and/or other objects proximate the target object.

The planning component 630 may receive a location and/or orientation of the vehicle 602 from the localization component 620, perception data from the perception component 622, and/or predicted trajectories from the prediction component 628, and may determine instructions for controlling operation of the vehicle 602 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 626 and/or drive systems(s) 614 may parse/cause to be carried out, second instructions for the emitter(s) 608 may be formatted according to a second format associated therewith). In at least one example, the planning component 630 may comprise a nominal trajectory generation subcomponent that generates a set of candidate trajectories, and selects a trajectory for implementation by the drive systems(s) 614 based at least in part on determining a cost associated with a trajectory according to U.S. patent application Ser. No. 16/517,506, filed Jul. 19, 2019 and/or U.S. patent application Ser. No. 16/872,284, filed May 11, 2020, the entirety of which are incorporated herein for all purposes.

The memory 618 and/or 640 may additionally or alternatively store a mapping system (e.g., generating a map based at least in part on sensor data), a planning system, a ride management system, etc. Although localization component 620, perception component 622, the prediction component 628, the planning component 630, and/or system controller(s) 626 are illustrated as being stored in memory 618, any of these components may include processor-executable instructions, machine-learned model(s) (e.g., a neural network), and/or hardware and all or part of any of these components may be stored on memory 640 or configured as part of computing device(s) 636.

As described herein, the localization component 620, the perception component 622, the prediction component 628, the planning component 630, and/or other components of the system 600 may comprise one or more ML models. For example, the localization component 620, the perception component 622, the prediction component 628, and/or the planning component 630 may each comprise different ML model pipelines. The prediction component 628 may use a different ML model or a combination of different ML models in different circumstances. For example, the prediction component 628 may use different GNNs, RNNs, CNNs, MLPs and/or other neural networks tailored to outputting predicted agent trajectories in different seasons (e.g., summer or winter), different driving conditions and/or visibility conditions (e.g., times when border lines between road lanes may not be clear or may be covered by snow), and/or based on different crowd or traffic conditions (e.g., more conservative trajectories in a crowded traffic conditions such as downtown areas, etc.). In various examples, any or all of the above ML models may comprise an attention mechanism, GNN, and/or any other neural network. An exemplary neural network is a biologically inspired algorithm which passes input data through a series of connected layers to produce an output. Each layer in a neural network can also comprise another neural network, or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3(ID3 ), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like.

Memory 618 may additionally or alternatively store one or more system controller(s) 626, which may be configured to control steering, propulsion, braking, safety, emitters, communication, and other systems of the vehicle 602. These system controller(s) 626 may communicate with and/or control corresponding systems of the drive systems(s) 614 and/or other components of the vehicle 602.

In an additional or alternate example, vehicle 602 and/or computing device(s) 636 may communicate (e.g., transmit and/or receive messages over network(s) 634) with one or more passenger devices (not shown). A passenger device may include, for example, a smart phone, portable computer such as a laptop or tablet, wearable device (e.g., smart glasses, smart watch, earpiece), and/or the like. Although a passenger device may be a device associated with a passenger that is discrete from device(s) of the autonomous vehicle, it is contemplated that the passenger device may be a sub-system and/or a device of the vehicle 602. For example, the passenger device may additionally or alternatively comprise a display and/or one or more input/output devices, such as a touchscreen, microphone, speaker, and/or the like. In some examples, the vehicle 602 may transmit messages and/or receive messages from the passenger device.

It should be noted that while FIG. 6 is illustrated as a distributed system, in alternative examples, components of the vehicle 602 may be associated with the computing device(s) 636 and/or components of the computing device(s) 636 may be associated with the vehicle 602. That is, the vehicle 602 may perform one or more of the functions associated with the computing device(s) 636, and vice versa.

### EXAMPLE CLAUSES

A. A system comprising: one or more processors; and one or more non-transitory computer-readable media storing computer-executable instructions that, when executed, cause the one or more processors to perform operations comprising: receiving data representing a driving scenario, the driving scenario including a first vehicle traversing through an intersection controlled by a traffic signal; receiving a set of parameters associated with a traffic signal subcomponent of a planning component; executing a driving simulation based at least in part on the driving scenario, wherein executing the driving simulation comprises: determining, using the planning component, a trajectory for a first simulated vehicle based at least in part on the set of parameters and a permissibility state of the traffic signal during the driving simulation; and controlling the first simulated vehicle during the driving simulation using the planning component in accordance with the trajectory; determining, based at least in part on the trajectory, a value associated with a performance metric; performing an optimization algorithm configured to optimize the set of parameters within a parameter search space, based at least in part on the value; determining a modified set of parameters based at least in part on an output of the optimization algorithm; and transmitting the modified set of parameters to a second vehicle, wherein the second vehicle is configured to use the modified set of parameters to control a driving behavior of the second vehicle.
B. The system of paragraph A, wherein determining the value associated with the performance metric comprises: determining the value based on a traffic signal cost function associated with a first time in the trajectory, wherein the traffic signal cost function is based at least in part on the set of parameters and a time difference between the first time and a second time in the trajectory when the traffic signal changes to a stop state.
C. The system of paragraph B, wherein traffic signal cost function is based at least in part on at least one of: a delay time parameter associated with a cost for the first vehicle occupying the intersection while the traffic signal is in a stop state; a maximum cost parameter associated with the cost of the first vehicle occupying the intersection while the traffic signal is in the stop state; or a cost rate parameter associated with the cost of the first vehicle occupying the intersection while the traffic signal is in the stop state.
D. The system of paragraph A, the operations further comprising: determining a parameter search space based at least in part on the set of parameters; performing a grid search on a parameter search space to determine, for a plurality of candidate parameter sets, a plurality of values associated with a second performance metric, wherein the second performance metric comprises at least one of: a vehicle collision metric; a passenger safety metric; or a metric indicating a maximum time for the first vehicle to occupy the intersection while the traffic signal is in a stop state; and modifying the parameter search space based at least in part on the plurality of values associated with the second performance metric.
E. The system of paragraph A, wherein the value associated with the performance metric comprises at least one of: a first amount of time in the trajectory between a first time when the first vehicle enters the intersection and a second time when the traffic signal changes to a non-permissible state; or a second amount of time in the trajectory that the first vehicle occupies the intersection while the traffic signal is in the non-permissible state.
F. A method comprising: receiving data representing a driving scenario, the driving scenario including a first vehicle traversing through an intersection controlled by a traffic signal; receiving a set of parameters associated with a traffic signal subcomponent of a planning component; determining, using the planning component, a trajectory for controlling the first vehicle through the intersection, based at least in part on the set of parameters and a permissibility state of the traffic signal; determining, based at least in part on the trajectory, a value associated with a performance metric; modifying at least one parameter of the set of parameters, based at least in part on the value, to determine a modified set of parameters; and transmitting the modified set of parameters to a second vehicle, wherein the second vehicle is configured to use the modified set of parameters to control a driving behavior of the second vehicle.
G. The method of paragraph F, wherein determining the value associated with the performance metric comprises: determining the value using a traffic signal cost function associated with a first time in the trajectory, wherein the traffic signal cost function is based at least in part on the set of parameters and a time difference between the first time and a second time in the trajectory when the traffic signal changes to a stop state.
H. The method of paragraph F, further comprising: determining a parameter search space based at least in part on the set of parameters; performing a grid search on a parameter search space to determine, for a plurality of candidate parameter sets, a plurality of values associated with a second performance metric, wherein the second performance metric comprises at least one of: a vehicle collision metric; a passenger safety metric; or a metric indicating a maximum time for the first vehicle to occupy the intersection while the traffic signal is in a stop state; and modifying the parameter search space based at least in part on the plurality of values associated with the second performance metric.
I. The method of paragraph F, wherein the value associated with the performance metric comprises at least one of: a first amount of time in the trajectory between a first time when the first vehicle enters the intersection and a second time when the traffic signal changes to a stop state; or a second amount of time in the trajectory that the first vehicle occupies the intersection while the traffic signal is in the stop state.
J. The method of paragraph F, wherein the set of parameters includes at least one of: a delay time parameter associated with a cost for the first vehicle occupying the intersection while the traffic signal is in a stop state; a maximum cost parameter associated with the cost of the first vehicle occupying the intersection while the traffic signal is in the stop state; or a cost rate parameter associated with the cost of the first vehicle occupying the intersection while the traffic signal is in the stop state.
K. The method of paragraph F, wherein the driving scenario comprises a first driving scenario, the trajectory comprises a first trajectory, the value comprises a first value, and wherein determining the value associated with the performance metric comprises: receiving a plurality of driving scenarios including the first driving scenario; determining a plurality of trajectories for controlling the first vehicle, based at least in part on the set of parameters, the plurality of trajectories corresponding to the plurality of driving scenarios; determining a plurality of values associated with the performance metric, based on the plurality of trajectories; and determining an aggregate value associated with the performance metric, based at least in part on the plurality of values.
L. The method of paragraph F, wherein determining the trajectory comprises: executing a driving simulation including a first simulated vehicle associated with the first vehicle; and controlling the first simulated vehicle during the driving simulation using the planning component and the set of parameters.
M. The method of paragraph F, wherein determining the value associated with the performance metric comprises: determining, by the planning component, a change in the traffic signal to a yellow light state during the driving scenario; determining, by the planning component, an estimated duration of the yellow light state; and determining a cost associated with the trajectory of the first vehicle, using the set of parameters, wherein the cost is based at least in part on the estimated duration of the yellow light state.
N. One or more non transitory computer readable media storing instructions executable by a processor, wherein the instructions, when executed, cause the processor to perform operations comprising: receiving data representing a driving scenario, the driving scenario including a first vehicle traversing through an intersection controlled by a traffic signal; receiving a set of parameters associated with a traffic signal subcomponent of a planning component; determining, using the planning component, a trajectory for controlling the first vehicle through the intersection, based at least in part on the set of parameters and a permissibility state of the traffic signal; determining, based at least in part on the trajectory, a value associated with a performance metric; modifying at least one parameter of the set of parameters, based at least in part on the value, to determine a modified set of parameters; and transmitting the modified set of parameters to a second vehicle, wherein the second vehicle is configured to use the modified set of parameters to control a driving behavior of the second vehicle.
O. The one or more non transitory computer readable media of paragraph N, wherein determining the value associated with the performance metric comprises: determining the value using a traffic signal cost function associated with a first time in the trajectory, wherein the traffic signal cost function is based at least in part on the set of parameters and a time difference between the first time and a second time in the trajectory when the traffic signal changes to a stop state.
P. The one or more non transitory computer readable media of paragraph N, the operations further comprising: determining a parameter search space based at least in part on the set of parameters; performing a grid search on a parameter search space to determine, for a plurality of candidate parameter sets, a plurality of values associated with a second performance metric, wherein the second performance metric comprises at least one of: a vehicle collision metric; a passenger safety metric; or a metric indicating a maximum time for the first vehicle to occupy the intersection while the traffic signal is in a stop state; and modifying the parameter search space based at least in part on the plurality of values associated with the second performance metric.
Q. The one or more non transitory computer readable media of paragraph N, wherein the value associated with the performance metric comprises at least one of: a first amount of time in the trajectory between a first time when the first vehicle enters the intersection and a second time when the traffic signal changes to a stop state; or a second amount of time in the trajectory that the first vehicle occupies the intersection while the traffic signal is in the stop state.
R. The one or more non transitory computer readable media of paragraph N, wherein the set of parameters includes at least one of: a delay time parameter associated with a cost for the first vehicle occupying the intersection while the traffic signal is in a stop state; a maximum cost parameter associated with the cost of the first vehicle occupying the intersection while the traffic signal is in the stop state; or a cost rate parameter associated with the cost of the first vehicle occupying the intersection while the traffic signal is in the stop state.
S. The one or more non transitory computer readable media of paragraph N, wherein the driving scenario comprises a first driving scenario, the trajectory comprises a first trajectory, the value comprises a first value, and wherein determining the value associated with the performance metric comprises: receiving a plurality of driving scenarios including the first driving scenario; determining a plurality of trajectories for controlling the first vehicle, based at least in part on the set of parameters, the plurality of trajectories corresponding to the plurality of driving scenarios; determining a plurality of values associated with the performance metric, based on the plurality of trajectories; and determining an aggregate value associated with the performance metric, based at least in part on the plurality of values.
T. The one or more non transitory computer readable media of paragraph N, wherein determining the trajectory comprises: executing a driving simulation including a first simulated vehicle associated with the first vehicle; and controlling the first simulated vehicle during the driving simulation using the planning component and the set of parameters.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing computer-executable instructions that, when executed, cause the one or more processors to perform operations comprising:
receiving data representing a driving scenario, the driving scenario including a first vehicle traversing through an intersection controlled by a traffic signal;
receiving a set of parameters associated with a traffic signal subcomponent of a planning component;
executing a driving simulation based at least in part on the driving scenario, wherein executing the driving simulation comprises:
determining, using the planning component, a trajectory for a first simulated vehicle based at least in part on the set of parameters and a permissibility state of the traffic signal during the driving simulation; and
controlling the first simulated vehicle during the driving simulation using the planning component in accordance with the trajectory;
determining, based at least in part on the trajectory, a value associated with a performance metric;
performing an optimization algorithm configured to optimize the set of parameters within a parameter search space, based at least in part on the value;
determining a modified set of parameters based at least in part on an output of the optimization algorithm; and
transmitting the modified set of parameters to a second vehicle, wherein the second vehicle is configured to use the modified set of parameters to control a driving behavior of the second vehicle.

2. The system of claim 1, wherein determining the value associated with the performance metric comprises:
determining the value based on a traffic signal cost function associated with a first time in the trajectory, wherein the traffic signal cost function is based at least in part on the set of parameters and a time difference between the first time and a second time in the trajectory when the traffic signal changes to a stop state.

3. The system of claim 2, wherein traffic signal cost function is based at least in part on at least one of:
a delay time parameter associated with a cost for the first vehicle occupying the intersection while the traffic signal is in a stop state;
a maximum cost parameter associated with the cost of the first vehicle occupying the intersection while the traffic signal is in the stop state; or
a cost rate parameter associated with the cost of the first vehicle occupying the intersection while the traffic signal is in the stop state.

4. The system of claim 1, the operations further comprising:
determining a parameter search space based at least in part on the set of parameters;
performing a grid search on a parameter search space to determine, for a plurality of candidate parameter sets, a plurality of values associated with a second performance metric, wherein the second performance metric comprises at least one of:
a vehicle collision metric;
a passenger safety metric; or
a metric indicating a maximum time for the first vehicle to occupy the intersection while the traffic signal is in a stop state; and
modifying the parameter search space based at least in part on the plurality of values associated with the second performance metric.

5. The system of claim 1, wherein the value associated with the performance metric comprises at least one of:
a first amount of time in the trajectory between a first time when the first vehicle enters the intersection and a second time when the traffic signal changes to a non-permissible state; or
a second amount of time in the trajectory that the first vehicle occupies the intersection while the traffic signal is in the non-permissible state.

6. A method comprising:
receiving data representing a driving scenario, the driving scenario including a first vehicle traversing through an intersection controlled by a traffic signal;
receiving a set of parameters associated with a traffic signal subcomponent of a planning component;
determining, using the planning component, a trajectory for controlling the first vehicle through the intersection, based at least in part on the set of parameters and a permissibility state of the traffic signal;
determining, based at least in part on the trajectory, a value associated with a performance metric;
modifying at least one parameter of the set of parameters, based at least in part on the value, to determine a modified set of parameters; and
transmitting the modified set of parameters to a second vehicle, wherein the second vehicle is configured to use the modified set of parameters to control a driving behavior of the second vehicle.

7. The method of claim 6, wherein determining the value associated with the performance metric comprises:
determining the value using a traffic signal cost function associated with a first time in the trajectory, wherein the traffic signal cost function is based at least in part on the set of parameters and a time difference between the first time and a second time in the trajectory when the traffic signal changes to a stop state.

8. The method of claim 6, further comprising:
determining a parameter search space based at least in part on the set of parameters;
performing a grid search on a parameter search space to determine, for a plurality of candidate parameter sets, a plurality of values associated with a second performance metric, wherein the second performance metric comprises at least one of:
a vehicle collision metric;
a passenger safety metric; or
a metric indicating a maximum time for the first vehicle to occupy the intersection while the traffic signal is in a stop state; and
modifying the parameter search space based at least in part on the plurality of values associated with the second performance metric.

9. The method of claim 6, wherein the value associated with the performance metric comprises at least one of:
a first amount of time in the trajectory between a first time when the first vehicle enters the intersection and a second time when the traffic signal changes to a stop state; or
a second amount of time in the trajectory that the first vehicle occupies the intersection while the traffic signal is in the stop state.

10. The method of claim 6, wherein the set of parameters includes at least one of:
a delay time parameter associated with a cost for the first vehicle occupying the intersection while the traffic signal is in a stop state;
a maximum cost parameter associated with the cost of the first vehicle occupying the intersection while the traffic signal is in the stop state; or
a cost rate parameter associated with the cost of the first vehicle occupying the intersection while the traffic signal is in the stop state.

11. The method of claim 6, wherein the driving scenario comprises a first driving scenario, the trajectory comprises a first trajectory, the value comprises a first value, and wherein determining the value associated with the performance metric comprises:
receiving a plurality of driving scenarios including the first driving scenario;
determining a plurality of trajectories for controlling the first vehicle, based at least in part on the set of parameters, the plurality of trajectories corresponding to the plurality of driving scenarios;
determining a plurality of values associated with the performance metric, based on the plurality of trajectories; and
determining an aggregate value associated with the performance metric, based at least in part on the plurality of values.

12. The method of claim 6, wherein determining the trajectory comprises:
executing a driving simulation including a first simulated vehicle associated with the first vehicle; and
controlling the first simulated vehicle during the driving simulation using the planning component and the set of parameters.

13. The method of claim 6, wherein determining the value associated with the performance metric comprises:
determining, by the planning component, a change in the traffic signal to a yellow light state during the driving scenario;
determining, by the planning component, an estimated duration of the yellow light state; and
determining a cost associated with the trajectory of the first vehicle, using the set of parameters, wherein the cost is based at least in part on the estimated duration of the yellow light state.

14. One or more non-transitory computer-readable media storing instructions executable by a processor, wherein the instructions, when executed, cause the processor to perform operations comprising:
receiving data representing a driving scenario, the driving scenario including a first vehicle traversing through an intersection controlled by a traffic signal;
receiving a set of parameters associated with a traffic signal subcomponent of a planning component;
determining, using the planning component, a trajectory for controlling the first vehicle through the intersection, based at least in part on the set of parameters and a permissibility state of the traffic signal;
determining, based at least in part on the trajectory, a value associated with a performance metric;
modifying at least one parameter of the set of parameters, based at least in part on the value, to determine a modified set of parameters; and
transmitting the modified set of parameters to a second vehicle, wherein the second vehicle is configured to use the modified set of parameters to control a driving behavior of the second vehicle.

15. The one or more non-transitory computer-readable media of claim 14, wherein determining the value associated with the performance metric comprises:
determining the value using a traffic signal cost function associated with a first time in the trajectory, wherein the traffic signal cost function is based at least in part on the set of parameters and a time difference between the first time and a second time in the trajectory when the traffic signal changes to a stop state.

16. The one or more non-transitory computer-readable media of claim 14, the operations further comprising:
determining a parameter search space based at least in part on the set of parameters;
performing a grid search on a parameter search space to determine, for a plurality of candidate parameter sets, a plurality of values associated with a second performance metric, wherein the second performance metric comprises at least one of:
a vehicle collision metric;
a passenger safety metric; or
a metric indicating a maximum time for the first vehicle to occupy the intersection while the traffic signal is in a stop state; and
modifying the parameter search space based at least in part on the plurality of values associated with the second performance metric.

17. The one or more non-transitory computer-readable media of claim 14, wherein the value associated with the performance metric comprises at least one of:
a first amount of time in the trajectory between a first time when the first vehicle enters the intersection and a second time when the traffic signal changes to a stop state; or
a second amount of time in the trajectory that the first vehicle occupies the intersection while the traffic signal is in the stop state.

18. The one or more non-transitory computer-readable media of claim 14, wherein the set of parameters includes at least one of:
a delay time parameter associated with a cost for the first vehicle occupying the intersection while the traffic signal is in a stop state;
a maximum cost parameter associated with the cost of the first vehicle occupying the intersection while the traffic signal is in the stop state; or
a cost rate parameter associated with the cost of the first vehicle occupying the intersection while the traffic signal is in the stop state.

19. The one or more non-transitory computer-readable media of claim 14, wherein the driving scenario comprises a first driving scenario, the trajectory comprises a first trajectory, the value comprises a first value, and wherein determining the value associated with the performance metric comprises:
receiving a plurality of driving scenarios including the first driving scenario;
determining a plurality of trajectories for controlling the first vehicle, based at least in part on the set of parameters, the plurality of trajectories corresponding to the plurality of driving scenarios;
determining a plurality of values associated with the performance metric, based on the plurality of trajectories; and
determining an aggregate value associated with the performance metric, based at least in part on the plurality of values.

20. The one or more non-transitory computer-readable media of claim 14, wherein determining the trajectory comprises:
executing a driving simulation including a first simulated vehicle associated with the first vehicle; and
controlling the first simulated vehicle during the driving simulation using the planning component and the set of parameters.
